(19) United States
(12) Patent Application Publication
(10) Pub. No.: US 2007/0207807 A1
(43) Pub. Date: Sep. 6, 2007

(54) METHOD AND SYSTEM FOR SPEED ESTIMATION IN A NETWORK

(76) Inventor: Adrian Duda, London (GB)

Correspondence Address: THORNE & HALAJIAN;APPLIED TECHNOLOGY CENTER, 111 WEST MAIN STREET, BAY SHORE, NY, 11706, US

(21) Appl. No.: 11/680,636

(22) Filed: Mar. 1, 2007

(30) Foreign Application Priority Data
Mar. 2, 2006 (EP) EP06290355.4

(51) Int. Cl. H04Q 7/20

(52) U.S. Cl. 455/441; 455/456.1

(57) ABSTRACT

Estimating the speed of a mobile user terminal within a wireless environment and estimating the time when a mobile user terminal would reach a coverage border of the access point it is currently associated with. In particular, the present system is concerned with calculating a time (T) the terminal would take to move from a point A, after it has stopped making received signal level measurements, to another point B, at the coverage border of the access point, independently of any medium-specific parameters. This way, the present system enhances Quality of Service by properly estimating the speed and time and enabling a terminal, or an entity in the network, to take preemptive actions to ensure optimal QoS.

### FIELD OF THE PRESENT SYSTEM

The present system relates to network mobility. In particular, the present system relates to estimating the speed of a mobile terminal in a communications network.

### BACKGROUND OF THE PRESENT SYSTEM

With the proliferation of convergent services like voice over wireless LAN (VoWLAN), there is a need to better control the WLAN environment in order to provide an adequate quality of services to users.

Typically, various speed estimation methods have been advanced such as estimation processes where a given instant is used to estimate the impulse response as well the time derivative of the estimated impulse response of the transmission channel. With others, speed estimation is executed by establishing predetermined models to which further measurements are later compared. For example, US2002068581 describes a speed estimation method, which can be applied in cellular radio systems. In particular, the subscriber terminal speed is estimated by using a probability theory where the speed of the subscriber terminal is matched to a predetermined model that is based on measurements made within the area of the radio system and which is a cell-specific model.

However, none of these systems provide a satisfactory solution for wireless LAN systems. That is, these existing techniques are applied to estimate the speed of a mobile terminal in communication with a station via a transmission channel within a cellular network rather than a WLAN. One obvious disadvantage of these proposed methods are that they involve establishing a set of reference points within the networks, or predetermined models to which further measurements must be compared to. As a result, lack of quality of service, robustness, and increased costs contribute to the shortcomings faced in these existing techniques.

Therefore, in view of these concerns there is a continuing need for developing a new and improved method and system for efficient speed estimation which would avoid the disadvantages and above mentioned problems while being cost effective and simple to implement.

### SUMMARY OF THE PRESENT SYSTEM

Accordingly, it is an object of the present system to provide an improved method and system to estimate the speed of a mobile user terminal, for example, within a WLAN environment. In one embodiment, the present system includes a method of estimating a speed of a mobile user terminal, said terminal being positioned at a first instant in a first point associated with at least one access point in a RF coverage radius, having a first distance between the first point and the at least one access point, wherein the user terminal has a trajectory, said terminal experiencing a received signal level along the trajectory, in that the method further includes the acts of:
performing periodic measurements of the received signal level of the terminal along the trajectory, wherein the received signal level comprises its strength indication;
determining a second point along the trajectory, wherein the received signal level is a maximum of the periodic measurements; said second point corresponding to a second instant, and
computing the speed of the mobile user terminal using the first distance, the strength indications at the first and second points and the time between the first and second instants.

One or more of the following features may also be included.

In one aspect of the present system, the method further computes a time when the mobile user terminal would reach the coverage border of the access point.

Embodiments may have one or more of the following advantages.

In order to compute time T, no assumptions are made about medium specific parameters or access point coverage. Therefore, advantageously, the time T may be calculated so the result does not depend on the medium-specific parameters. This is performed irrespective of whether the mobile terminal is under a call with a station via a transmission channel, or only traverses the WLAN, without having a session open.

Furthermore, the present system advantageously enhances the fact that properly estimating the speed and time as mentioned above enables the terminal, or an entity in the network, to take preemptive actions to make sure the QoS experienced by the terminal is at an optimal level. Such actions may involve handing over the user terminal to a different network before the terminal is dangerously close to the coverage of the access point.

Additionally, in the present system, the speed of a mobile terminal may be estimated without making use of systems such as GPS, or of other methods requiring training processes, such as establishing certain reference points in the network whose locations are known. In other words, there may be no need to maintain any “static” preconfigured set of points in the network to be used as reference for comparisons. Consequently, the speed of the terminal and the time when the terminal reaches the coverage border of the access point can be efficiently estimated with a high degree of accuracy since the method of estimating the speed and time does not involve any medium-specific parameters.

The present system also relates to a system configured to estimate a speed of a mobile user terminal, a mobile user terminal itself arranged to estimate its own speed, and a computer program product.

These and other aspects of the present system will become apparent from and elucidated with reference to the embodiments described in the following description, drawings and from the claims.

### BRIEF DESCRIPTION OF THE DRAWINGS

FIG. 1 illustrates a mobile user terminal diagram, illustrating the implementation of an improved method and system according to one of the embodiments of the present system;

FIG. 2 is a graph illustrating the RSSI attenuation as a logarithmic function, according to one of the embodiments of the present system;

FIG. 3 is a flowchart of the improved method according to one of the embodiments of the present system;

FIG. 4 illustrates an implementation of the system according to the present system; FIG. 5 illustrates an implementation of the mobile user terminal according to the present system; and

FIG. 6 shows a mobile user terminal in accordance with an embodiment of the present system.

### DETAILED DESCRIPTION

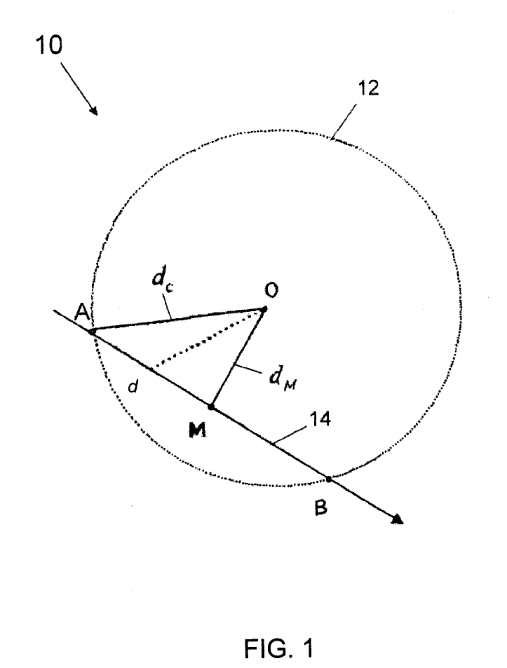

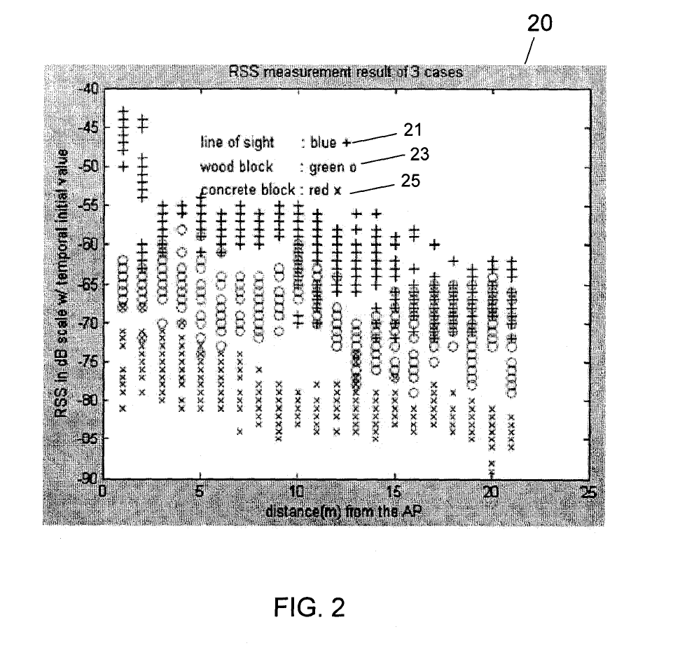

Referring to FIG. 1, a mobile user terminal diagram 10 is shown. In the diagram 10, a mobile user terminal is in a radio frequency coverage radius 12, following along a trajectory 14. A mobile terminal is initially attached to the access point “O” at point “A” and has a relatively (e.g., substantially) straight trajectory in the direction \vec{AB} (trajectory 14). As utilized herein, the terms relatively and/or substantially straight is intended to convey that the trajectory, in accordance with an illustrative embodiment, does not deviate substantially from a straight path by more than may be typical for example by a pedestrian, motorist, etc. intending to take a straight path, but by which may be deviated from an exactitude of straightness. For example, walking a substantially straight path that may include a slight deviation. The trajectory 14 can be approximated or interpolated to be a relatively in straight direction \vec{AB}. The point “B” represents the point coverage border of the access point “O”. A point “M” represents the point along the trajectory 14 where an experienced received signal level value, for example, a Received Signal Strength Indication (hereinafter “RSSI”) at the terminal is at its maximum, and d_{c} represents the coverage of the access point “O”, for implementing the process of speed estimation and time estimation within the known coverage radius 12.

Still referring to FIG. 1, the mobile user terminal performs periodic measurements of an experienced RSSI. As the mobile user terminal moves alongside \vec{AB} along the trajectory 14, the experienced RSSI has the a small value at point “A” as compared to further points along the trajectory 14. As the user terminal approaches point “M”, the experienced RSSI gradually increases. The RSSI increases at a higher pace when the mobile user terminal is closer to point M than when it is closer to point “A”, and the RSSI tends to have a maximum value closest to point M. Consequently, as the mobile user terminal moves further away from point M towards point B, the experienced RSSI decreases.

The RSSI measurements are performed in the mobile user terminal until a generally decreasing change in the slope of the RSSI occurs. To this end, the signal typically decreases for a given length of time in order to determine where along the trajectory 14 the decreasing trend has started. This beginning of the change in the slope (e.g., a point or portion wherein the increasing trend ends and a decreasing trend begins) corresponds to point “M” as shown in FIG. 1. Smaller oscillations of the RSSI may be ignored and only the beginning portion of a global decreasing trend (e.g., generally decreasing irrespective of oscillations) is taken into consideration for purposes of determining where the decreasing trend has taken place.

Referring now to FIG. 2, a graph 20 of an RSS measurement for three cases is illustrated, i.e., as represented by symbols 21, 23, and 25. FIG. 2 shows the change of RSSI attenuation when a mobile user terminal passes straight through the coverage of an access point within the coverage radius. In other words, the RSSI attenuation constitutes a logarithmic function, which, irrespective of the medium, changes more slowly when it is closer to the border of the access point, and more sharply when it is closer to the centre of the access point. This can be noted in the graph 20, for example, when the distance is smallest (e.g., near 0 m from the Access Point, AP), the RSSI measurements are more obvious and transparent than the RSSI measurements near the border of the access point (e.g., near 20 m from the AP).

In particular, symbol 21 marked as “line of sight: blue+” represents a change of RSSI attenuation when the mobile user terminal and the AP are in “line of sight,” i.e., free of any obstacles. Symbol 23 marked as “wood block:

Furthermore, some of the parameters of formula (1) are medium specific, and some means are provided to eliminate most of the parameters with only one parameter remaining, i.e., the path loss exponent. The path loss exponent can be estimated to the value 2.5 because the impact of the path loss exponent to the final estimating value of the speed is small.

For example, if for two distances d₁ and d₂, the difference between RSSI(d₁) and RSSI(d₂) is computed, due to the fact that in a WLAN environment the transmitted power at the access point is relatively constant and the noise oscillation small, the following formula (2) may be obtained:

$$RSSI ( {d}_{1} ) - RSSI ( {d}_{2} ) = 10 η ( {log}_{10} \frac{{d}_{2}}{{d}_{1}} - {log}_{10} \frac{{d}_{1}}{{d}_{0}} ) = 10 η {log}_{10} \frac{{d}_{2}}{{d}_{1}} \qquad ( 2 )$$

The result in formula (2) is independent of the medium-specific parameters PL(d₀), X_{δ}, as well as of the transmit power of the access point P_{T}. As mentioned previously, the only medium-specific parameter which remains is the path loss exponent η. The free space path loss is represented by η=2, while the average path loss exponent is 2.5 thus it may be safely assumed that η=2.5.

Referring back to FIG. 1, once point “M” mentioned above has been located, a distance d_{M} between points “O” and “M” can be determined by formula (2). Advantageously, Formula (2) excludes some medium-specific parameters contained in formula (1). For example, the coverage radius of the access point (d_{c}) may be considered to be 100 meters. Using the Pythagorean theorem, the distance (d) between points “A” and “M” may be green o″ represents a change of RSSI attenuation when the mobile user terminal and the AP are separated by “wood block” types of materials, and symbol 25 marked as “concrete block: red x” represents a change of RSSI attenuation when the mobile user terminal and the AP are separated by the thickness of “concrete block” type of materials, such as concrete buildings, walls, etc.

In a WLAN, the following formula may be considered to describe the attenuation of the RSSI.

$$RSSI ( d ) = {P}_{T} - PL ( {d}_{0} ) - 10 η log \frac{d}{{d}_{0}} + {X}_{σ} \qquad ( 1 )$$

where P_{T} represents the transmit power, PL(d₀) is the path loss for a reference distance d₀, η represents the path loss exponent and X_{δ} is a Gaussian random variable with zero mean and δ₂ variance that models the random variation of the RSSI value.

The formula (1) above describes the attenuation of the RSSI on the mobile user terminal side within a radio environment. This formula may also be applied for the cellular environment as well to describe the relation between the received signal strength as a function of the distance between the mobile user terminal and a base station. However, due to the fact that in a cellular environment, noise is significantly more present and the transmitted power at the base station has large variations, it may be difficult to use the formula in an iterative way. This is due to the fact that the medium-specific parameters may not be neglected. But in a WLAN system, the transmitted power at the access point typically is relatively constant and the noise oscillation relatively small, which makes it realistic to apply formula (1). calculated based on d_{c} and d_{M}. Considering a time T_{M}, taken until the mobile user terminal has reached point “M,” the speed may then be expressed by the relation, v=d/T_{M}.

In view of the foregoing, a general process for speed estimation and time estimation has been described. For further computations, a mathematical series theory may be used, as described below in (I) through (III):

I. If a series (xₙ)_{n=1, . . . N} has the property:

$${S}_{{x}_{1} , N} = {\sum }_{n = 1}^{N} x ( n ) * sin ( - \frac{2 π n}{N} ) < 0 , then series {( {x}_{n} )}_{n = 1 , … N}$$

is
decreasing [formula (3)]

### II. If S>0, then series (xₙ)_{n=1, . . . N} is increasing.

III. If two series (xₙ)_{n=1, . . . N} and (yₘ)_{m=1, . . . M}, then if Sₓ_{_{1,N}}≧S_{y}_{_{1,M}}, series (xₙ) has a more pronounced changing trend (either increasing or decreasing) than series (yₘ). Additionally, if Sₓ_{_{1,N}}<S_{y}_{_{1,M}}, series (xₙ) changes more slowly than the series (yₘ).

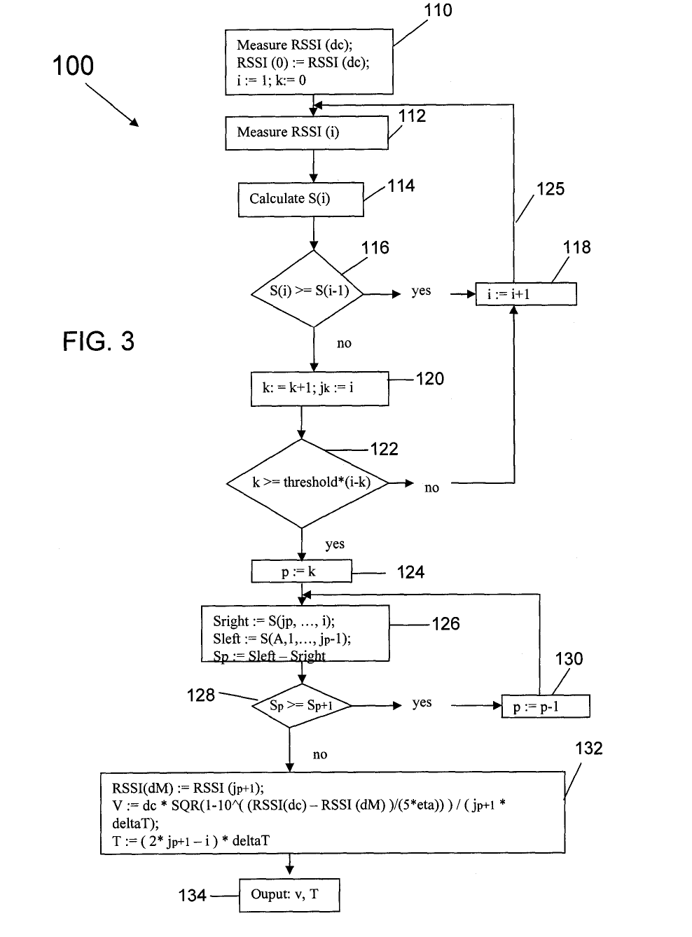

Referring now to FIG. 3, a flowchart 100 shows the steps of a process for estimating the speed of a mobile terminal within a WLAN environment, as well as of estimating the time when the mobile user terminal reaches the coverage border of its current access point. Specifically, flowchart 100 illustrates a sequence of actions in order to determine values of the speed estimation and time estimation processes.

Assuming that the mobile user terminal is currently at point “A” (i.e., attached to the access point “O” as shown in FIG. 1), the distance between the mobile user terminal and point “O” is d_{c}, which, for example, equals 100 m. The method of the present system may be divided into distinct steps and/or acts.

First, in FIG. 3, act 110, when the mobile user terminal is at point “A” (FIG. 1), the RSSI is measured and stored in a variable RSSI. The RSSI variable is the RSSI value the mobile user terminal has measured after i*ΔT milliseconds from the moment the mobile user terminal has attached to the access point “O”. At this moment, the mobile user terminal has also memorized the previous RSSI values, i.e., RSSI_{A}, RSSI₁, . . . , RSSIᵢ₋₁ (act 112).

Next, the Sᵢ value is computed (act 114). The Sᵢ is the S value as calculated using the formula (3) above, based on the measured values RSSI_{A}, RSSI₁, . . . , RSSIᵢ₋₁, RSSIᵢ. In a following act 116, if Sᵢ>=Sᵢ₋₁, then the RSSIᵢ₊₁ is measured in an act 118. However, if Sᵢ<Sᵢ₋₁ is the case, then the value of i.(=jₖ) is retained and a decreasing change in the slope of the measured RSSI values occurs (step 120). If it is the first time when Sᵢ<Sᵢ₋₁, then k=1 (act 120).

Thereafter, in acts 122 and 125, the mobile user terminal performs the above mentioned computations (acts 112 through 120) until k>=threshold*(i−k) [condition (4)]. In this condition (4), k represents the number of times when the condition Sᵢ<Sᵢ₋₁ is fulfilled, and i−k represents the number of times when the condition Sᵢ>=Sᵢ₋₁ is met.

Additionally, the threshold represents the minimum value of the ratio between the number of times when the RSSI has increased, and the number of times when it has decreased locally. Preferably, a threshold of ¼ may be used, although anything between ⅛ and ½ may also be used for the further calculations. As a result, when the condition (4) is satisfied, the RSSI is in a decreasing trend.

Thereafter, in acts 124 through 130, when condition (4) above is satisfied, namely, k>=threshold*(i−k), the point where a decreasing change in the trend of the RSSI has occurred can be determined along all the points (j), i.e., where a decreasing change in the RSSI slope has taken place. As mentioned above, this point corresponds to the point “M” in the FIG. 1. This point will be the one (jₚ) in the vector of j elements for which:

S_{A,1, . . . j}_{ₚ}₋₁−S_{J}_{ₚ}_{,j}_{ₚ}_{+1, . . . ,i} is maximum (5)

For each jₚ, in the vector (j)_{p=k, . . . ,1} (starting with p=k and then decreasing it, as shown in step 124), the following computations are carried out (step 126):

S_{right}=Sⱼ_{ₚ}_{. . . ,i} based on the formula (3) above

S_{left}=S_{A,1, . . . ,J}_{ₚ}₋₁ (S_{A,1, . . . ,J}_{ₚ}₋₁ has already been calculated, as above)

Sₚ=S_{left}−S_{right}

If in act 128, Sₚ>=Sₚ₊₁, then the steps proceed with the next p (act 130).

However, if in act 128, Sₚ<Sₚ₊₁, then p+1 is retained. The maximum mentioned in the relation (5) above is determined (=RSSIⱼ_{_{P+1}}). RSSIⱼ_{ₚ₊₁}, represents the RSSI measurement taken when the mobile user terminal is substantially at the point “M” in FIG. 1.

Next, using the above formula (2), the following is obtained:

$$RSSI ( {d}_{c} ) - RSSI ( {d}_{M} ) = 10 η ( {log}_{10} \frac{{d}_{M}}{{d}_{0}} - {log}_{10} \frac{{d}_{c}}{{d}_{0}} ) = 10 η {log}_{10} \frac{{d}_{M}}{{d}_{c}} \qquad ( 6 )$$

In the above, X_{d}_{_{c}}−X_{d}_{_{M}} [from formula (1)] is approximated to the value 0. The impact upon the final result of this estimation is small. From here, it can be implied that:

$${d}_{M} = {d}_{C} * 10 \hat{} [ \frac{RSSI ( {d}_{c} ) - RSSI ( {d}_{M} )}{10 η} ] \qquad ( 7 )$$

Now, the distance between points “A” and “M” can be approximated by: ∥AM∥=\sqrt{d_{c}²−d_{M}²} (assuming the trajectory is a relatively straight trajectory and using the Pythagorean theorem), and the speed of the mobile user terminal can be estimated by

$$v = \frac{‖ AM ‖}{{T}_{M}} ,$$

where T_{M} represents the time for the user terminal to go from point “A” to point “M.” Based on the previous terminology and computations, the result is the relation T_{M}=jₚ₊₁*ΔT.

Finally, the formula for the calibration speed Vc (speed measured at the initial act 110 in FIG. 3) is given by the following relation:

$$\begin{matrix}Vc = \frac{{d}_{c} * \sqrt{1 - {10}^{Λ} [ \frac{RSSI ( {d}_{c} ) - RSSI ( {d}_{{M}_{c}} )}{5 η} ]}}{{j}_{p + 1} * Δ T} \\ and & ( 8 ) \\ V = \frac{{d}_{c} * \sqrt{1 - {10}^{Λ} [ \frac{RSSI ( {d}_{c} ) - RSSI ( {d}_{M} )}{5 η} ]}}{{j}_{p + 1} * Δ T} & ( 8 A )\end{matrix}$$

As RSSI(d_{M}) may be measured without knowing d_{M}, the calculation of V is independent of the distance d_{M}. Then, Vc, the calibration speed is used to calculate the speed V:

$$V = {V}_{c} \frac{{j}_{{p}_{c} + 1} \sqrt{1 - 10 \hat{} [ \frac{RSSI ( {d}_{c} ) - RSSI ( {d}_{M} )}{5 η} ]}}{{j}_{p + 1} \sqrt{1 - 10 \hat{} [ \frac{RSSI ( {d}_{c} ) - RSSI ( {d}_{{M}_{c}} )}{5 η} ]}} \qquad ( 8 B )$$

In the above equation (8B), neither d_{M} nor the distance AM is required to arrive at the computation of the speed V.

As described above, in FIG. 3, in a act 132, the RSSI(d_{M}) is first computed and then V is obtained. Furthermore, from the moment when the RSSI measurement has been stopped, a time T is computed representing the time it would take for the mobile user terminal to reach the coverage of that access point. Because the triangle joining points “A”, “O”, “B” is an isosceles, and OM⊥AB, we have the relation ∥AM∥=∥MB∥, and then T may be computed by the following formula:

T=2*T_{M}−i*ΔT (9)

Consequently, the flowchart 100 provides the estimated speed and time in an act 134. In the T expression above, no reference has been made to any of the medium-specific parameters, therefore the result has a very high degree of accuracy.

If all the above processing and computations are carried out in the mobile user terminal, then the mobile user terminal may consider the estimated time that it can remain in the current access point, and take preemptive actions, i.e., such as handing over to a different network before critical coverage is lost. Therefore, the sequence of steps and computations of flowchart 100 may be easily mapped into a conceptual software to be implemented on a mobile user terminal device.

To that extend, the present system also relates, as seen in FIG. 5 to a mobile user terminal 21 configured to estimate its speed, said mobile user terminal being positioned at a first instant in a first point 21 (point A in FIG. 1) associated with at least one access point 25 (access point O in FIG. 1) in a RF coverage radius 12, having a first distance d_{c} between the first point 21 and the access point 25, wherein said mobile user terminal has a trajectory 14, said mobile user terminal 21 experiencing a received signal level along the trajectory 14, said mobile user terminal 21 being configured to:
perform periodic measurements of the received signal level of the terminal along the trajectory 14, wherein the received signal level comprises its strength indication;
determine a second point 22 (point M of FIG. 1) along the trajectory 14, wherein the received signal level is a maximum of the periodic measurements; said second point 22 corresponding to a second instant, and
compute the speed of the mobile user terminal using the first distance d_{c}, the strength indications at the first 21 and second 22 points and the time between the first and second instants.

For the computation of the time T, the point coverage border B of FIG. 1 corresponds to position 23 in FIG. 5.

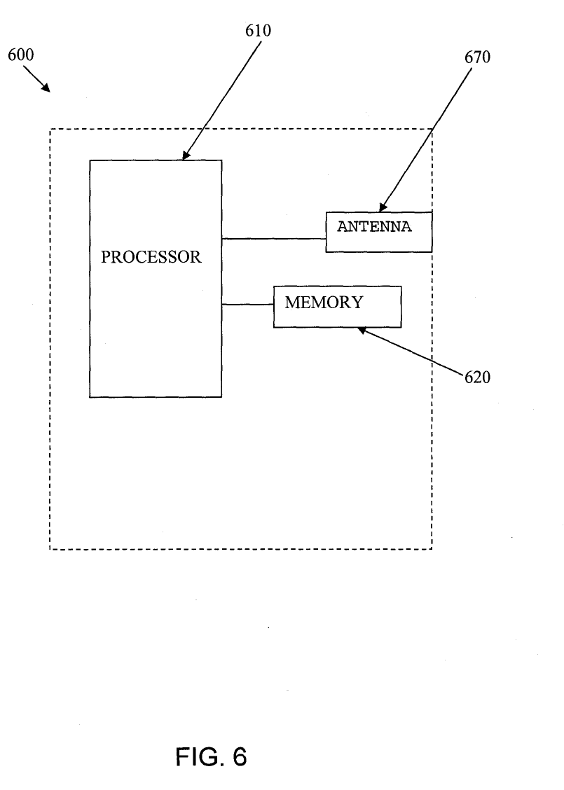

FIG. 6 shows a mobile user terminal 600 in accordance with an embodiment of the present system. The device has a processor 610 operationally coupled to a memory 620 and a device, such as an antenna 670 for communicating with an access point. The memory 620 may be any type of device for storing programming application data as well as other data. The programming application data and other data are received by the processor 610 for configuring the processor 610 to perform operation acts in accordance with the present system

The methods of the present system are particularly suited to be carried out by a computer software program, such program containing modules corresponding to one or more of the individual steps or acts described and/or envisioned by the present system. Such program, etc. may of course be embodied in a computer-readable medium, such as an integrated chip, a peripheral device or memory, such as the memory 620 and/or other an memory coupled to the processor 610.

The memory 620 may be any recordable medium (e.g., RAM, ROM, removable memory, CD-ROM, hard drives, DVD, floppy disks or memory cards) or may be a transmission medium (e.g., a network comprising fiber-optics, the world-wide web, cables, a wireless channel using time-division multiple access, code-division multiple access, or other radio-frequency or wireless communication channel such as connected to the access point). Any medium known or developed that may store and/or transmit information suitable for use with a computer system may be used as the memory 620.

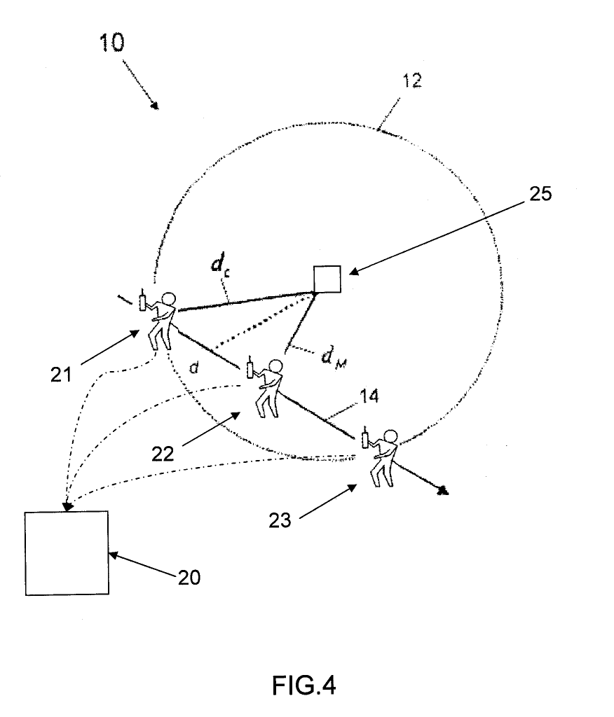

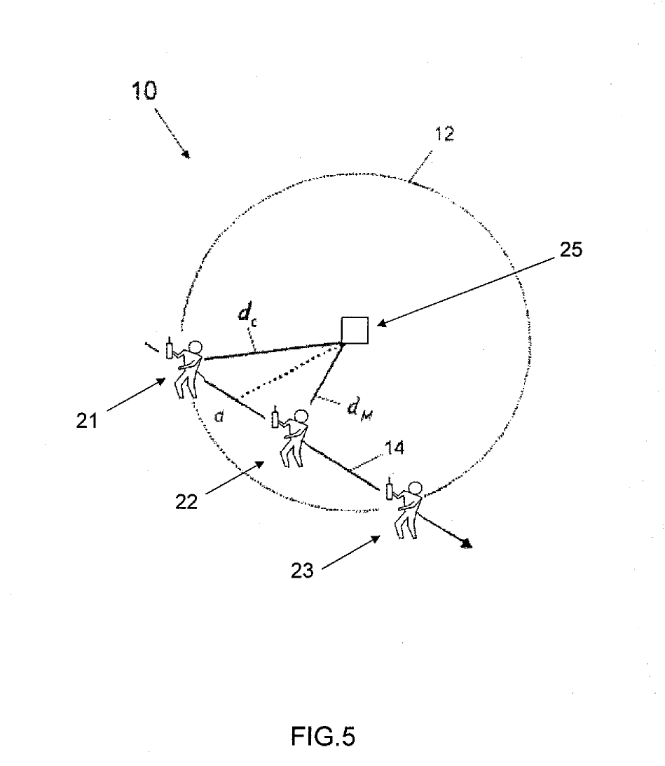

The memory 620 may be distributed or local and the processor 610, where additional processors may be provided, may also be distributed (e.g., see FIG. 4) or may be singular. The memory 620 may configure the processor 610 to implement the methods, operational acts, and functions disclosed herein. The memory 620 may be implemented as electrical, magnetic or optical memory, or any combination of these or other types of storage devices. Moreover, the term “memory” should be construed broadly enough to encompass any information able to be read from or written to an address in the addressable space accessible by a processor. With this definition, information on a network is still within memory 620, for instance, because the processor 610 may retrieve the information from the network for operation in accordance with the present system.

The processor 610 may be an application-specific and/or general-use integrated circuit(s). Further, the processor 610 may be a dedicated processor for performing in accordance with the present system and/or may be a general-purpose processor wherein only one of many functions operates for performing in accordance with the present system. The processor 610 may operate utilizing a program portion, multiple program segments, and/or may be a hardware device utilizing a dedicated or multi-purpose integrated circuit.

Of course, it is to be appreciated that any one of the above embodiments or processes may be combined with one or more other embodiments and/or processes or be separated and/or performed amongst separate devices or device portions in accordance with the present system.

While there has been illustrated and described what are presently considered to be embodiments of the present system, it will be understood by those of ordinary skill in the art that various other modifications may be made, and equivalents may be substituted, without departing from the true scope of the present system.

In particular, although the foregoing description related mostly to processing performed at the terminal level, the speed and time estimation described herein can be applied in a situation where the terminal 21 sends the measured RSSI values to a component in the network or a system module 20 as seen in FIG. 4 (see the dotted lines for the sending of the measurements between the different positions of mobile user terminal 21 to 23 and system module 20), which makes the above calculations for the respective mobile terminal and based on the estimated time left for the user in the current access point 25, makes the computations and processing necessary to implement QoS decisions, inter alia, such as when to handover the user to a different network. For example, the system module 20 may contain a processor or a portion thereof similar as described with regard to FIG. 6.

Additionally, many advanced modifications may be made to adapt a particular situation to the teachings of the present system without departing from the central inventive concept described herein. Furthermore, an embodiment of the present system may not include all of the features described above. Therefore, it is intended that the present system not be limited to the particular embodiments disclosed, but that the present system include all embodiments falling within the scope of the appended claims and their equivalents. In addition, the section headings included herein are intended to facilitate a review but are not intended to limit the scope of the present system. Accordingly, the specification and drawings are to be regarded in an illustrative manner and are not intended to limit the scope of the appended claims.

In interpreting the appended claims, it should be understood that:

a) the word “comprising” does not exclude the presence of other elements or acts than those listed in a given claim;

b) the word “a” or “an” preceding an element does not exclude the presence of a plurality of such elements;

c) any reference signs in the claims do not limit their scope;

d) several “means” may be represented by the same item or hardware or software implemented structure or function;

e) any of the disclosed elements may be comprised of hardware portions (e.g., including discrete and integrated electronic circuitry), software portions (e.g., computer programming), and any combination thereof;

f) hardware portions may be comprised of one or both of analog and digital portions;

g) any of the disclosed devices or portions thereof may be combined together or separated into further portions unless specifically stated otherwise;

h) no specific sequence of acts or steps is intended to be required unless specifically indicated; and

i) the term “plurality of” an element includes two or more of the claimed element, and does not imply any particular range of number of elements; that is, a plurality of elements may be as few as two elements, and may include an immeasurable number of elements.

1. A method of estimating a speed of a mobile user terminal, said terminal being positioned at a first instant in a first point associated with at least one access point in a RF coverage radius, having a first distance between the first point and the at least one access point, wherein the user terminal has a trajectory, said terminal experiencing a received signal level along the trajectory, wherein the method comprises the acts of:
performing periodic measurements of the received signal level of the terminal along the trajectory, wherein the received signal level comprises its strength indication;
determining a second point along the trajectory, wherein the received signal level is a maximum of the periodic measurements; said second point corresponding to a second instant, and
computing the speed of the mobile user terminal using the first distance, the strength indications at the first and second points and the time between the first and second instants.

2. The method of claim 1, wherein the act of computing the speed further comprises the acts of:
estimating a second distance between the at least one access point and the second point along the trajectory of the terminal using the received signal level of the first point, the second point and the first distance,
computing the distance between the first and second points based on the first and second distances, and
computing the speed of the user terminal as the ratio of the distance between the first and second points and the time between the first and second instants.

3. The method of claim 2, wherein the trajectory is assumed to be a substantially straight trajectory, and in the act of computing the distance between the first and second points, said distance is calculated as:
d=\sqrt{d_{c}²−d_{M}²}
wherein d is the distance between the first and second points, d_{c} is the first distance and d_{M} is the second distance.

4. The method of claim 1, further comprising the act of calculating the time it takes from the moment the mobile user terminal has stopped performing signal measurements until the moment the mobile user terminal reaches the at least one coverage border of the access point, said time being given by the relation:
T=2*T_{M}−i*ΔT,
wherein T represents the time, i represents the number of signal measurements performed by the mobile user terminal, ΔT represents the time between two consecutive measurements, T_{M} represents the time when the terminal has reached the second point.

5. The method of claim 1, wherein the act of determining the second point further comprising the act of:
analyzing the attenuation of the received signal level of the terminal along the trajectory using a mathematical series theory to determine the second point by determining whether the received signal level is increasing or decreasing.

6. The method of claim 1, wherein the act of computing the speed of the mobile user terminal comprises the act of:
calculating the speed by the relation:
$$V = \frac{{d}_{c} * \sqrt{1 - 10 \hat{} [ \frac{RSSI ( {d}_{c} ) - RSSI ( {d}_{M} )}{5 η} ]}}{{j}_{p + 1} * Δ T}$$
wherein V is the speed, η comprises the medium-specific parameter path loss exponent, jₚ₊₁ represents the number of measurements performed by the terminal from the first point to the second point, ΔT represents the time between two consecutive measurements, d_{c} the first distance, d_{M} the second distance, RSSI(d) represents the received signal level measured at a distance d from the access point.

7. The method of claim 1, further comprising the act of transmitting the measured received signal level from the mobile user terminal to a wireless network component, said network component computing the speed of said mobile user terminal.

8. The method of claim 1, wherein the mobile user terminal computes the speed of said mobile user terminal.

9. A computer program product to be stored on a device and having a sequence of instructions stored thereon which, when executed by a microprocessor of the device, causes the microprocessor to estimate a speed of a mobile user terminal, said terminal being positioned at a first instant in a first point associated with at least one access point in a RF coverage radius, having a first distance between the first point and the at least one access point, wherein the user terminal has a trajectory, said terminal experiencing a received signal level along the trajectory, said sequences of instructions comprising:
instructions to perform periodic measurements of the received signal level of the terminal along the trajectory, wherein the received signal level comprises its strength indication;
instructions to determine a second point along the trajectory, wherein the received signal level is a maximum of the periodic measurements; said second point corresponding to a second instant, and
instructions to compute the speed of the mobile user terminal using the first distance, the strength indications at the first and second points and the time between the first and second instants.

10. The computer program product of claim 9, wherein the instructions to compute the speed further comprise:
instructions to estimate a second distance between the at least one access point and the second point along the trajectory of the terminal using the received signal level of the first point, the second point and the first distance,
instructions to compute the distance between the first and second points based on the first and second distances, and
instructions to compute the speed of the user terminal as the ratio of the distance between the first and second points and the time between the first and second instants.

11. The computer program product of claim 10, wherein the trajectory is assumed to be a substantially straight trajectory, and wherein the distance between the first and second points is calculated as:
d=\sqrt{d_{c}²−d_{M}²}
wherein d is the distance between the first and second points, d_{c} is the first distance and d_{M} is the second distance.

12. The computer program product of claim 9, further comprising the instructions to calculate the time it takes from the moment the mobile user terminal has stopped performing signal measurements until the moment the mobile user terminal reaches the at least one coverage border of the access point, said time being given by the relation:
T=2*T_{M}−i*ΔT,
wherein T represents the time, i represents the number of signal measurements performed by the mobile user terminal, ΔT represents the time between two consecutive measurements, T_{M} represents the time when the terminal has reached the second point.

13. The computer program product of claim 9, wherein the instructions to compute the speed of the mobile user terminal comprise instructions to calculate the speed by the relation:
$$V = \frac{{d}_{c} * \sqrt{1 - 10 \hat{} [ \frac{RSSI ( {d}_{c} ) - RSSI ( {d}_{M} )}{5 η} ]}}{{j}_{p + 1} * Δ T}$$
wherein V is the speed, η comprises the medium-specific parameter path loss exponent, jₚ₊₁ represents the number of measurements performed by the terminal from the first point to the second point, ΔT represents the time between two consecutive measurements, d_{c} the first distance, d_{M} the second distance, RSSI(d) represents the received signal level measured at a distance d from the access point.

14. A system configured to estimate a speed of a mobile user terminal, said terminal being positioned at a first instant in a first point associated with at least one access point in a RF coverage radius, having a first distance between the first point and the at least one access point, wherein said mobile user terminal has a trajectory, said terminal experiencing a received signal level along the trajectory, said mobile user terminal being configured to:
perform periodic measurements of the received signal level of the terminal along the trajectory, wherein the received signal level comprises its strength indication;
the system further comprising a system module configured to:
determine a second point along the trajectory, wherein the received signal level is a maximum of the periodic measurements; said second point corresponding to a second instant, and
compute the speed of the mobile user terminal using the first distance, the strength indications at the first and second points and the time between the first and second instants.

15. The system of claim 14, wherein the mobile user terminal is configured to transmit the measurements of the received signal levels to the system module.

16. The system of claim 14, the system module is further configured to:
estimate a second distance between the at least one access point and the second point along the trajectory of the terminal using the received signal level of the first point, the second point and the first distance,
compute the distance between the first and second points based on the first and second distances, and
compute the speed of the user terminal as the ratio of the distance between the first and second points and the time between the first and second instants.

17. The system of claim 14, wherein the trajectory is assumed to be a substantially straight trajectory, and wherein the system module is further configured to compute the distance between the first and second points using the relation:
d=\sqrt{d_{c}²−d_{M}²}
wherein d is the distance between the first and second points, d_{c} is the first distance and d_{M} is the second distance.

18. The system of claim 14, wherein the system module is further configured to calculate the time it takes from the moment the mobile user terminal has stopped performing signal measurements until the moment the mobile user terminal reaches the at least one coverage border of the access point (T), said time being given by the relation:
T=2*T_{M}−i*ΔT,
wherein T represents the time, i represents the number of signal measurements performed by the mobile user terminal, ΔT represents the time between two consecutive measurements, T_{M} represents the time when the terminal has reached the second point.

19. The system of claim 14, wherein the system module is further configured to calculate the speed using the relation:
$$V = \frac{{d}_{c} * \sqrt{1 - 10 \hat{} [ \frac{RSSI ( {d}_{c} ) - RSSI ( {d}_{M} )}{5 η} ]}}{{j}_{p + 1} * Δ T}$$
wherein V is the speed, η comprises the medium-specific parameter path loss exponent, jₚ₊₁ represents the number of measurements performed by the terminal from the first point to the second point, ΔT represents the time between two consecutive measurements, d_{c} the first distance, d_{M} the second distance, RSSI(d) represents the received signal level measured at a distance d from the access point.

20. A mobile user terminal configured to estimate its speed, said mobile user terminal being positioned at a first instant in a first point associated with at least one access point in a RF coverage radius, having a first distance between the first point and the at least one access point, wherein said mobile user terminal has a trajectory, said mobile user terminal experiencing a received signal level along the trajectory, said mobile user terminal being configured to:
perform periodic measurements of the received signal level of the terminal along the trajectory, wherein the received signal level comprises its strength indication;
determine a second point along the trajectory, wherein the received signal level is a maximum of the periodic measurements; said second point corresponding to a second instant, and
compute the speed of the mobile user terminal using the first distance, the strength indications at the first and second points and the time between the first and second instants.

21. The terminal of claim 20, wherein said terminal is further configured to:
estimate a second distance between the at least one access point and the second point along the trajectory of the terminal using the received signal level of the first point, the second point and the first distance,
compute the distance between the first and second points based on the first and second distances, and
compute the speed of the user terminal as the ratio of the distance between the first and second points and the time between the first and second instants.

22. The terminal of claim 20, wherein the trajectory is assumed to be a substantially straight trajectory, and wherein said terminal is further configured to compute the distance between the first and second points using the relation:
d=\sqrt{d_{c}²−d_{M}²}
wherein d is the distance between the first and second points, d_{c} is the first distance and d_{M} is the second distance.

23. The terminal of claim 20, wherein said terminal is further configured to calculate the time it takes from the moment the mobile user terminal has stopped performing signal measurements until the moment the mobile user terminal reaches the at least one coverage border of the access point (T), said time being given by the relation:
T=2*T_{M}−i*ΔT,
wherein T represents the time, i represents the number of signal measurements performed by the mobile user terminal, ΔT represents the time between two consecutive measurements, T_{M} represents the time when the terminal has reached the second point.

24. The terminal of claim 20, wherein said terminal is further configured to calculate the speed using the relation:
$$V = \frac{{d}_{c} * \sqrt{1 - 10 \hat{} [ \frac{RSSI ( {d}_{c} ) - RSSI ( {d}_{M} )}{5 η} ]}}{{j}_{p + 1} * Δ T}$$
wherein V is the speed, η comprises the medium-specific parameter path loss exponent, jₚ₊₁ represents the number of measurements performed by the terminal from the first point to the second point, ΔT represents the time between two consecutive measurements, d_{c} the first distance, d_{M} the second distance, RSSI(d) represents the received signal level measured at a distance d from the access point.
